(19) United States
(12) Patent Application Publication
(10) Pub. No.: US 2010/0205334 A1
(43) Pub. Date: Aug. 12, 2010

(54) Device wire adapter and communication control method to perform data transfer between wireless USB host and wired USB device

(75) Inventor: Masashi Tominaga, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,989

(22) Filed: Jan. 12, 2010

(30) Foreign Application Priority Data
Feb. 6, 2009 (JP) 2009-025898

(51) Int. Cl. G06F 13/12

(52) U.S. Cl. 710/65

(57) ABSTRACT

A device wire adapter performs a data transfer between a host which has been wirelessly connected to an upstream side and a wired device which has been wired-connected to a downstream side. The device wire adapter includes a control unit which controls the data transfer between the host and the wired device, and an end point on which a configuration information related to the data transfer can be changed. The data transfer between the host and the wired device is performed via the end point on which the configuration information has been changed based on configuration information on an end point included in the wired device.

### INCORPORATION BY REFERENCE

This application is based upon and claims the benefit of priority from Japanese Patent Application No. 2009-025898 which was filed on Feb. 6, 2009, the disclosure of which is incorporated herein in its entirety by reference.

### BACKGROUND OF THE INVENTION

1. Field of the Invention

The present invention relates to a device wire adapter which connects a wireless USB (universal serial bus) host to an upstream-side port, connects a wired USB device to a downstream-side port, and performs data transfer between both. It should be noted that, in the following description, wireless USB is referred to as “WUSB”, which thereby is distinguished from USB which is assumed to be for wired connections.

2. Description of Related Art

A device wire adapter (which may be hereinafter referred to as “DWA”.) is described such as Wireless Universal Serial Bus Specification Revision 1.0, Chapter 8, p195-p202, [online], URL: http://www.usb.org/developers/wusb/, which connects a WUSB host to an upstream-side port (which may be hereinafter referred to as “up-port”.), connects a wired USB device to a downstream-side port (which may be hereinafter referred to as “down-port”.), and performs data transfer between both.

FIG. 8 is a block diagram showing the DWA in a wireless USB communication system described in the Non Patent Literature. A DWA 410 includes a WiMedia RF & BB block 411, a WUSB controller 412, and a USB Transceiver Receiver 419.

The WUSB controller 412 controls the data transfer between a WUSB host 430 and wired USB devices 420_1 to 420_{—}n (which may be hereinafter collectively referred to by reference numeral 420.) connected to the down-ports of the DWA 410.

Consequently, the WUSB controller 412 includes Data Transfer Pair end points (a Bulk-IN end point 413 and a Bulk-OUT end point 414), a Notification end point (an INT-IN end point 415), a Control end point 416, an Isochronous end point 417_1 to an Isochronous end point 417_{—}k (which may be hereinafter collectively referred to by reference numeral 417.), and a remote pipe (which may be hereinafter referred to as “RPIPE”.) 418.

In the DWA 410, the up-port is wirelessly connected to the WUSB host 430 according to a predetermined wireless communication protocol. Moreover, the DWA 410 performs a data transfer process between the WUSB host 430 and the wired USB device 420 connected to the down-port.

If the wired USB device 420 is the wired USB device 420 having a Bulk-IN end point and a Bulk-OUT end point, then the data transfer between the WUSB host 430 and the wired USB device 420 is performed via the Data Transfer Pair end points (the Bulk-IN end point 413 and the Bulk-OUT end point 414). Here, since the DWA 410 is a DWA compliant with a wireless USB standard, when the data transfer between the WUSB host 430 and the wired USB device 420 is performed, a device wire adapter protocol is applied to all.

### SUMMARY

However, referring to the inventor's study, in the DWA 410 described in the Non Patent Literature, since the device wire adapter protocol is applied to all when the data transfer between the WUSB host 430 and the wired USB device 420 is performed, there has been a problem of reduced communication efficiency for the data transfer performed between the wired USB device 420 and the WUSB host 430 via the DWA 410. Particularly, there has been a problem in that communication performance is significantly reduced for USB devices requiring high throughput (execution speed), such as a storage device and an image processing device.

Hereinafter, a principle of occurrence of such problems will be specifically described. First, the device wire adapter protocol applied when the data transfer between the WUSB host 430 and the wired USB device 420 is performed will be described.

In the device wire adapter protocol, communication between the wired USB device 420 and the WUSB host 430 is performed by designating the RPIPE 418 which has associated the end point 413 to the end point 417 of the DWA 410 with an end point of the wired USB device 420. More specifically, the WUSB host 430 creates association between the end point of the wired USB device 420 connected to the DWA 410 and the RPIPE 418, and performs the data transfer to/from the wired USB device 420 via the DWA 410 with reference to the created association.

For example, if the WUSB host 430 performs Bulk transfer in a down (OUT) direction, then the WUSB host 430 transmits a Transfer Request (a request for transfer) to the DWA 410. At this time, in the Transfer Request to be transmitted, which RPIPE 418 in the DWA 410 data is transmitted to is designated. Following the transmission of the Transfer Request, the WUSB host 430 transmits the data to the end point for Bulk-OUT transfer 414 of the DWA 410. Then, the DWA 410 which has received the data uses the designated RPIPE 418 to transfer the data from the end point for the Bulk-OUT transfer 414 to the end point for the Bulk transfer of the wired USB device 420.

Therefore, if the WUSB host 430 performs the data transfer via the end point 414 associated with the RPIPE 418, then the WUSB host 430 cannot directly designate the end point of the wired USB device 420 to transmit the data, and needs to transmit the Transfer Request including information on the designation of the RPIPE 418.

Next, the data transfer process performed via the DWA 410 will be specifically described by using FIGS. 9 and 10. Here, the data transfer process performed via the DWA 410 between the WUSB host 430 and the wired USB devices 420_1 to 420_2 will be described.

It should be noted that examples shown in FIGS. 9 and 10 will be described assuming that the wired USB device 420 has the end point (which may be hereinafter referred to as “EP”.) for the Bulk transfer which requires the high throughput, and the DWA 410 supports such a wired USB device 420. Consequently, in the examples shown in FIGS. 9 and 10, the Bulk transfer will be described by way of example.

Moreover, in the examples shown in FIGS. 9 and 10, it is assumed that if the Data Transfer end point 413 which is the end point for Bulk-IN transfer is EP3, the Data Transfer end point 414 which is the end point for the Bulk-OUT transfer is EP2, the Notification end point 415 is EP1, and the Control end point 416 is EP0, then the DWA 410 performs the Bulk transfer by using EP2 and EP3.

Furthermore, in the examples shown in FIGS. 9 and 10, it is assumed that when the DWA 410 has been wirelessly connected to the WUSB host 430, an address 1 (which may be hereinafter referred to as “Adr1”.) has already been assigned to the DWA 410 by the WUSB host 430, and configuration for configuration information on the end point of the DWA 410 has been performed. Thereby, the WUSB host 430 performs the communication between the WUSB host 430 and the end point of the DWA 410 by designating the address and an end point number of the DWA 410, in a token packet to be transmitted.

First, the data transfer process performed via the DWA 410 from the WUSB host 430 to the wired USB devices 420_1 to 420_2 in the down (OUT) direction will be specifically described by using FIG. 9.

In FIG. 9, for example, a case where DATA-A is transferred from the WUSB host 430 to the wired USB device 420_2 will be described. First, the Transfer Request is transmitted from the WUSB host 430 to EP2 of the DWA 410. Following the transmission of the Transfer Request, the DATA-A is transmitted from the WUSB host 430 to the DWA 410. The DWA 410 stores the received DATA-A in EP2. The RPIPE 418 for transmitting the data has been designated in the Transfer Request, and following an OUT token, the DWA 410 transmits the DATA-A stored in EP2, via the RPIPE 418 to the wired USB device 4202. The DWA 410 which has transmitted the DATA-A generates a Transfer Result (a result of the transfer), and transmits the generated Transfer Result to the WUSB host 430 by using EP3. Subsequently, also for the transfer of DATA-B, DATA-C and DATA-D, the transfer is repeatedly performed similarly to the case of transferring the DATA-A.

Next, the data transfer process performed via the DWA 410 from the wired USB devices 420_1 to 420_2 to the WUSB host 430 in an up (IN) direction will be specifically described by using FIG. 10.

In FIG. 10, for example, a case where DATA-E is transferred from the wired USB device 420_2 to the WUSB host 430 will be described. First, the Transfer Request is transmitted from the WUSB host 430 to EP2 of the DWA 410. Following the transmission of the Transfer Request, the DWA 410 issues an IN token to the wired USB device 420_2, and subsequently, the DATA-E is transmitted from the wired USB device 420_2 to the DWA 410. The DWA 410 stores the received DATA-E in the designated RPIPE 418. Moreover, the DWA 410 generates the Transfer Result, and transmits the generated Transfer Result to the WUSB host 430 by using EP3. Then, the DWA 410 transmits the DATA-E stored in the RPIPE 418 to the WUSB host 430 by using EP3. Subsequently, also for the transfer of DATA-F, DATA-G and DATA-H, the transfer is repeatedly performed similarly to the case of transferring the DATA-E.

As described above, when the data transfer is performed via the DWA 410 between the WUSB host 430 and the wired USB device 420, the transmission of the Transfer Request and the Transfer Result needs to be performed for the data transfer in both the OUT direction and the IN direction. Consequently, an overhead of the protocol increases when the data transfer is performed, and the communication efficiency is reduced. More specifically, since the Transfer Request has a packet size of 24 bytes or 16 bytes, and the Transfer Result has a packet size of 16 bytes, issuance of a command through the Transfer Request and confirmation of a result of executing the command through the Transfer Result are performed for each unit of the data transfer, and thereby, extra packets occur for these packets, and the communication efficiency for the data transfer is reduced.

It should be noted that, as a related technique, Japanese Patent Laid-Open No. 2000-231458 (Patent Literature) describes a composite device apparatus in which at least two USB devices are mounted, and at least one of the USB devices controls an operation of the other USB device. The composite device apparatus described in Patent Literature 1 is a USB device mounted with a plurality of functions, in spite of physically being a single USB device. However, the composite device apparatus described in Patent Literature 1 cannot dynamically change the function itself of the mounted USB device, and, for example, in order to add a function of a USB hub to the composite device apparatus, hardware of the USB hub needs to be newly implemented.

Moreover, since the composite device apparatus described in Patent Literature 1 is a wired USB device which performs the communication via a USB cable, the composite device apparatus described in Patent Literature 1 cannot be easily applied to the wireless USB communication system.

A device wire adapter of a first aspect according to the present invention performs a data transfer between a host which has been wirelessly connected to an upstream side and a wired device which has been wired-connected to a downstream side. The device wire adapter includes a control unit which controls the data transfer between the host and the wired device, and an end point on which a configuration information related to the data transfer can be changed. The data transfer between the host and the wired device is performed via the end point on which the configuration information has been changed based on configuration information on an end point included in the wired device.

According to the device wire adapter according to the exemplary aspect of the present invention, if the data transfer is performed between the WUSB host and the wired USB device, the data transfer is performed via a dedicated end point, and thereby, the communication efficiency can be improved.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a block diagram showing a configuration of a device wire adapter according to an exemplary embodiment 1 of the present invention.

FIG. 2 is a diagram showing an example of a data transfer process performed by the device wire adapter according to the exemplary embodiment 1 of the present invention.

FIG. 3 is a diagram showing an example of the data transfer process performed by the device wire adapter according to the exemplary embodiment 1 of the present invention.

FIG. 4 is a block diagram showing the configuration of the device wire adapter according to an exemplary embodiment 2 of the present invention.

FIG. 5 is a block diagram showing the configuration of the device wire adapter according to the exemplary embodiment 2 of the present invention.

FIG. 6 is a diagram showing an example of the data transfer process performed by the device wire adapter according to the exemplary embodiment 2 of the present invention.

FIG. 7 is a diagram showing an example of the data transfer process performed by the device wire adapter according to the exemplary embodiment 2 of the present invention.

FIG. 8 is a block diagram showing a configuration of a related device wire adapter.

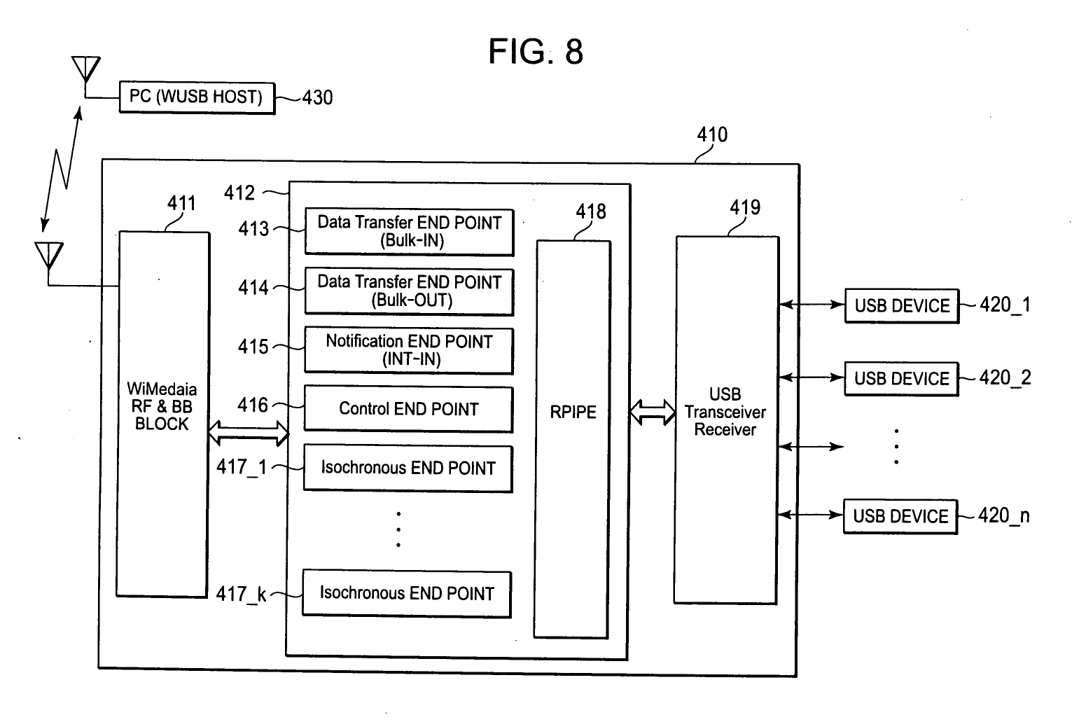

FIG. 9 is a diagram showing an example of a data transfer process performed by the related device wire adapter.

FIG. 10 is a diagram showing an example of the data transfer process performed by the related device wire adapter.

### DETAILED DESCRIPTION OF THE EXEMPLARY EMBODIMENTS

### Exemplary Embodiment 1

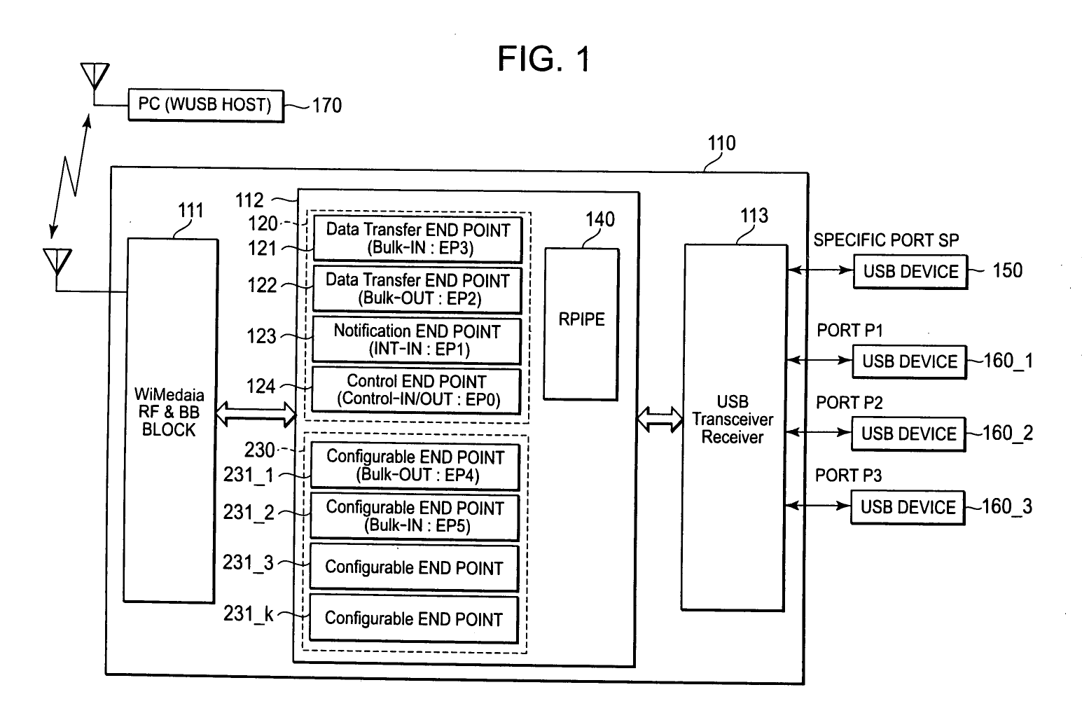

FIG. 1 is a block diagram showing a configuration of a DWA in a wireless USB communication system according to an exemplary embodiment 1 of the present invention. In a DWA 110, an up-port is wirelessly connected to a WUSB host 170 according to a predetermined wireless communication protocol. Moreover, the DWA 110 performs a data transfer process to/from the WUSB host 170, for wired USB devices 150 and 160_1 to 160_3 (which may be hereinafter collectively referred to by reference numeral 160.) connected to down-ports.

Here, the DWA 110 according to the exemplary embodiment 1 will be described assuming that the wired USB device 150 connected to a specific port SP on a downstream side is not dynamically inserted and removed and is fixed so that a function of the wired USB device 150 can be previously specified. The function of the wired USB device 150 can be previously specified by fixing the connection of the wired USB device 150 to the DWA 110. Thereby, as will be described later, prior to an enumeration process performed by the DWA 110, based on descriptor information on the wired USB device 150, configuration information on an end point of the DWA 110 can be previously changed, and thus a control process in the enumeration performed by the DWA 110 can be easier.

The DWA 110 includes a WiMedia RF & BB block 111, a WUSB controller 112, and a USB Transceiver Receiver 113.

The WUSB controller 112 controls data transfer between the WUSB host 170 and the wired USB devices 150 and 160 connected to the down-ports of the DWA 110. Consequently, the WUSB controller 112 includes a WUSB end point 120, a WUSB end point 230 of which a configuration can be changed, and an RPIPE 140. The WUSB end point 120 and the WUSB end point 230 are, for example, communication buffers such as a memory and a register.

The WUSB end point 120 is used for the data transfer between the WUSB host 170 and the wired USB devices 160_1 to 160_3 connected to a port P1 to a port P3 on the downstream side of the DWA 110, respectively. The WUSB end point 120 includes a Data Transfer end point 121, a Data Transfer end point 122, a Notification end point 123, and a Control end point 124.

The respective end points can be used for transmission, for reception, and for transmission and reception, respectively. As will be described later, at the time of the connection with the WUSB host 170, in response to a request from the WUSB host 170, the DWA 110 and the wired USB devices 150 and 160 respond with the configuration information on the end point which can be used for the communication.

The Data Transfer end point 121 is an end point for Bulk-IN transfer. In FIG. 1, the Data Transfer end point 121 is assigned with EP3 as an end point number. The Data Transfer end point 121 is used for transmitting data and a Transfer Result which are transmitted to the WUSB host 170. The Data Transfer end point 122 is an end point for Bulk-OUT transfer. In FIG. 1, the Data Transfer end point 122 is assigned with EP2 as the end point number. The Data Transfer end point 122 is used for receiving data and a Transfer Request which are transmitted from the WUSB host 170.

The Notification end point 123 is an interrupt IN (which may be hereinafter referred to as “INT-IN”.) end point used for periodically notifying the WUSB host 170 of a transfer status or the like. In FIG. 1, the Notification end point 123 is assigned with EP 1 as the end point number.

The Control end point 124 is an end point for Control-IN/OUT transfer. In FIG. 1, the Control end point 124 is assigned with EP0 as the end point number. It should be noted that, due to a specification of the USB communication system, the end point 0 (EP0) is used as an end point for control transfer. Consequently, the Control end point 124 can be used for transmitting and receiving a request command defined in a WUSB standard or a request command unique to a vendor.

The RPIPE 140 is used for the data transfer between the WUSB end point 120 of the DWA 110 and the end point included in the wired USB device 160. The WUSB host 170 performs the communication with a specific end point included in the wired USB device 160 by designating the RPIPE 140. The RPIPE 140 is, for example, the communication buffer such as the memory or the register.

The WUSB end point 230 is used for the data transfer between the WUSB host 170 and the wired USB device 150 connected to the specific port SP. The WUSB end point 230 includes a Configurable end point 231_1 to a Configurable end point 231_{—}k (which may be hereinafter collectively referred to by reference numeral 231.) of which the configurations can be changed. In FIG. 1, the Configurable end point 231_1 is assigned with EP4 as the end point number. Moreover, the Configurable end point 232_2 is assigned with EP5 as the end point number.

The Configurable end point 231 is an end point on which configuration information related to the data transfer can be changed. The configuration information is composed of various parameters related to the data transfer. Here, the parameters are a transfer type (Control transfer, Bulk transfer, INT transfer, or Isochronous transfer), a transfer direction (an IN direction or an OUT direction), an end point address, a Max Packet Size (maximum packet size), a Max Burst Size (maximum burst size) and the like, and the configuration information can be changed by changing at least one parameter among these parameters. As will be described later, the parameter of the Configurable end point 131 is changed depending on the configuration information on the end point included in the wired USB device 150 connected to the specific port SP, and the Configurable end point 131 is set to be one-to-one associated with the end point included in the wired USB device 150.

The DWA 110 and the wired USB devices 150 and 160 have the descriptor information for representing a function of the device. The descriptor information includes end point descriptor information indicating the configuration information on the end point included in the device. The end point descriptor information includes the configuration information on the end point, such as the end point number, the transfer type, the transfer direction and the maximum packet size.

Subsequently, a process for changing the configuration information on the Configurable end point 231 of the DWA 110 according to the exemplary embodiment 1 will be described. In the DWA 110 according to the exemplary embodiment 1, the process for changing the configuration information related to the Configurable end point 231 is performed, for example, by a vendor which manufactures a DWA chip mounted in the DWA 110, when an apparatus is manufactured. The manufacturing vendor changes the configuration information by using configuration information changing means (not shown) in the DWA 110 with reference to the descriptor information on the wired USB device 150.

Specifically, the configuration information on the end point of the wired USB device 150 is examined from the end point descriptor information included in the descriptor information on the wired USB device 150, and the parameter of the Configurable end point 231 is changed in accordance with the configuration information on the end point of the wired USB device 150.

Such a configuration information changing process is performed by the configuration information changing means for changing contents (including the parameters of the Configurable end point 231.) stored in a memory (nonvolatile) which is built in or external to the DWA chip. Thereby, an operation of an operation program of the DWA 110 (that is, the WUSB controller 112.) is changed.

In an example shown in FIG. 1, the wired USB device 150 has the end point for the Bulk-IN transfer and the end point for the Bulk-OUT transfer, and based on the descriptor information on the wired USB device 150 showing such a configuration, the configuration information on the Configurable end point 231_1 and the Configurable end point 231_2 is changed. Specifically, the parameter of the Configurable end point 231_1 is changed depending on the configuration information on the end point for the Bulk-OUT transfer of the wired USB device 150, and thereby, the configuration information is changed to the end point for the Bulk-OUT transfer, and moreover, the parameter of the Configurable end point 231_2 is changed depending on the configuration information on the end point for the Bulk-IN transfer of the wired USB device 150, and thereby, the configuration information is changed to the end point for the Bulk-IN transfer.

Subsequently, a process until it becomes a state where the communication between the WUSB host 170 and the wired USB devices 150 and 160 can be started will be described.

First, when the DWA 110 has been wirelessly connected to the WUSB host 170, the WUSB host 170 performs the enumeration with respect to the DWA 110. More specifically, the WUSB host 170 assigns an address which is unique in the system, to the DWA 110 (for example, the DWA 110 is assigned with Adr1.), and performs configuration for the configuration information on the end point of the DWA 110.

It should be noted that the enumeration denotes a series of processes in which the WUSB host 170 recognizes the DWA 110 and the wired USB devices 150 and 160 which have been wirelessly connected, and obtains information required for the communication. Moreover, the configuration denotes that the WUSB host 170 reads the descriptor information on the DWA 110 and the wired USB devices 150 and 160, and based on the read descriptor information, executes a predetermined process such as loading a driver or selecting an interface.

The WUSB host 170 which has recognized the configuration of the DWA 110 starts an operation for the communication with the DWA 110. Then, following the enumeration for the DWA 110, the WUSB host 170 performs the enumeration with respect to the wired USB devices 150 and 160 connected to the DWA 110. The WUSB host 170 starts an operation for the communication with the wired USB devices 150 and 160, from a time point when the configurations of the wired USB devices 150 and 160 have been recognized.

Through such an enumeration process, a pipe between the WUSB host 170 and the WUSB end point 120, and a pipe between the WUSB end point 120 and the end point included in the wired USB device 160 are associated with each other, which is set in the RPIPE 140. Thereby, the WUSB host 170 performs the communication with the wired USB devices 160_1 to 160_3 connected to the port P1 to the port P3, via the RPIPE 140.

Moreover, the end point included in the wired USB device 150 and the Configurable end point 231 on which the configuration information has been changed are set to be one-to-one associated with each other, and the WUSB host 170 performs the communication with the wired USB device 150 connected to the specific port SP, via the end point 230.

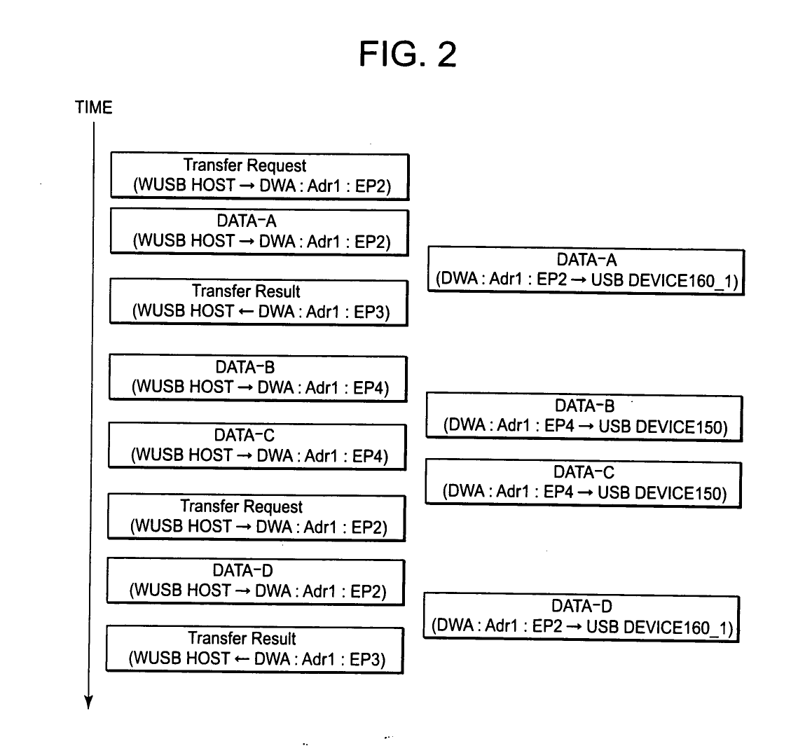

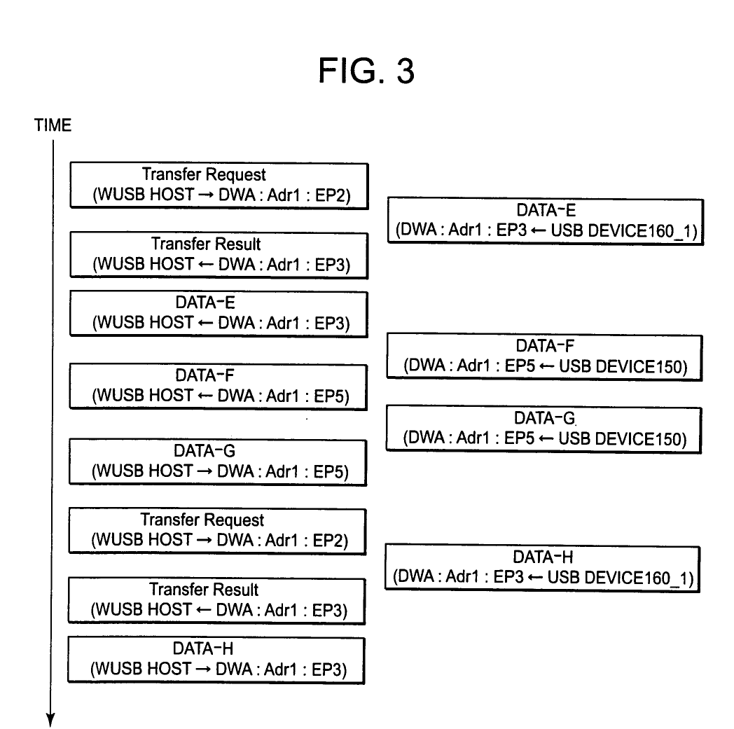

Hereinafter, with reference to FIGS. 2 and 3, the data transfer process performed via the DWA 110 according to the exemplary embodiment 1 will be described. In an example shown in FIG. 2, the data transfer process performed via the DWA 110 from the WUSB host 170 to the wired USB devices 150 and 160_1 in a down (OUT) direction will be described. In an example shown in FIG. 3, the data transfer process performed via the DWA 410 from the wired USB devices 150 and 160_1 to the WUSB host 170 in the down (IN) direction will be described.

It should be noted that the examples shown in FIGS. 2 and 3 will be described assuming that the wired USB devices 150 and 160 have the end point for the Bulk transfer, and the DWA 110 supports such wired USB devices 150 and 160. Consequently, the Bulk transfer will be described by way of example in the description of the data transfer process.

Moreover, in the examples shown in FIGS. 2 and 3, it is assumed that when the DWA 110 has been wirelessly connected to the WUSB host 170, Add has already been assigned to the DWA 110 by the WUSB host 170, and the configuration for the configuration information on the end point of the DWA 110 has been performed. Thereby, the WUSB host 170 performs the communication between the WUSB host 170 and the end point of the DWA 110 by designating the address and the end point number of the DWA 110, in a token packet.

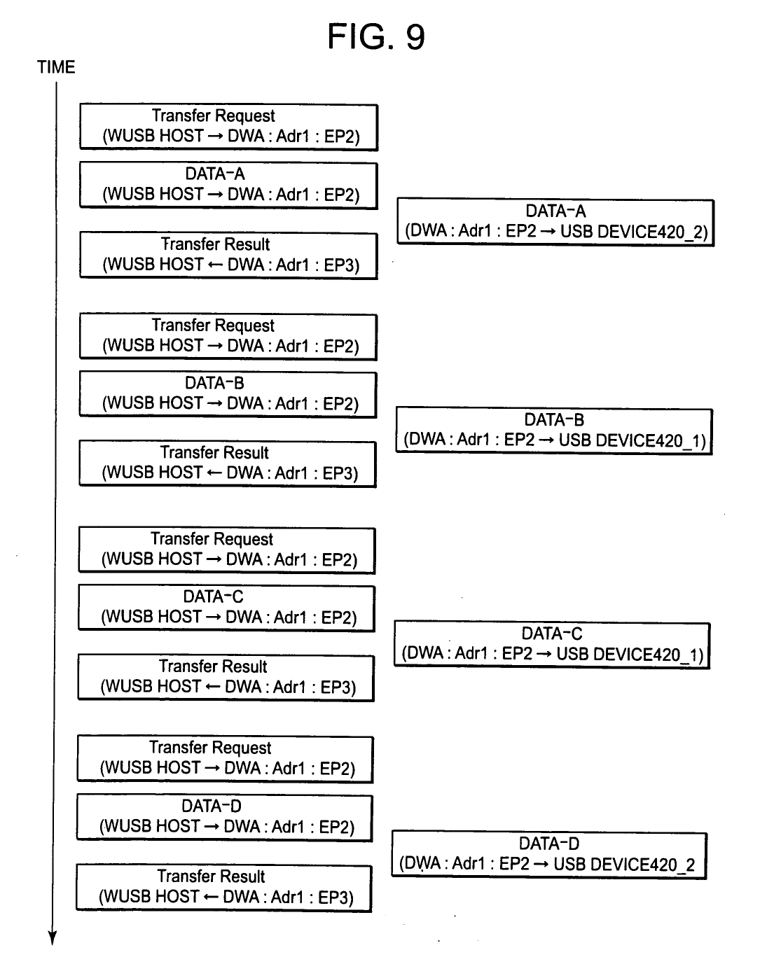

First, the data transfer process from the WUSB host 170 to the wired USB device 160_1 connected to the port P1 in the OUT direction will be specifically described by using FIG. 2. Here, since the transfer of DATA-A from the WUSB host 170 to the wired USB device 160_1 is the same as a case where the DATA-A is transferred from the WUSB host 430 to the wired USB device 420_2 in FIG. 9, a description thereof is omitted.

Next, a case where DATA-B and DATA-C are transferred from the WUSB host 170 to the wired USB device 150 connected to the specific port SP will be specifically described by using FIG. 2. First, the DATA-B is transmitted from the WUSB host 170 to the DWA 110. The DWA 110 stores the received DATA-B in EP4. Then, the DWA 110 transmits the DATA-B stored in EP4 to the end point for the Bulk transfer of the wired USB device 150. Subsequently, the DATA-C is transmitted from the WUSB host 170 to the DWA 110. The DWA 110 stores the received DATA-C in EP4. Then, the DWA 110 transmits the DATA-C stored in EP4 to the end point for the Bulk transfer of the wired USB device 150.

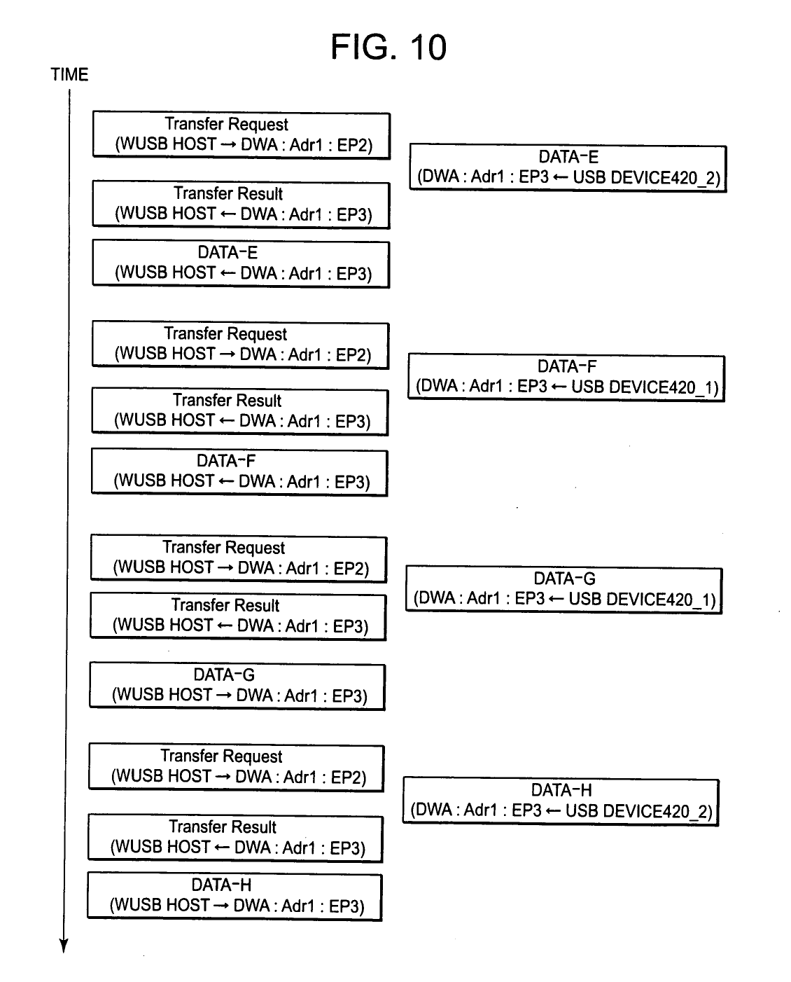

The data transfer process from the wired USB device 160_1 connected to the port P1, to the WUSB host 170 in the IN direction will be specifically described by using FIG. 3. Here, since the transfer of DATA-E from the wired USB device 160_1 to the WUSB host 170 is the same as a case where the DATA-E is transferred from the wired USB device 420_2 to the WUSB host 430 in FIG. 10, a description thereof is omitted.

Next, a case where DATA-F and DATA-G are transferred from the wired USB device 150 connected to the specific port SP, to the WUSB host 170, that is, a case where the WUSB host 170 reads the data from the wired USB device 150, will be specifically described by using FIG. 3. First, the DATA-F is transmitted from the end point for the Bulk transfer of the wired USB device 150 to the DWA 110. The DWA 110 stores the received DATA-F in EP5. Then, the DWA 110 transmits the DATA-F stored in EP5 to the WUSB host 170. Subsequently, the DATA-G is transmitted from the end point for the Bulk transfer of the wired USB device 150 to the DWA 110. The DWA 110 stores the received DATA-G in EP5. Then, the DWA 110 transmits the DATA-G stored in EP5 to the WUSB host 170.

In this way, if the data transfer to the wired USB device 150 connected to the specific port SP is performed (in the case of the data transfer in the OUT direction.), or if the data transfer from the wired USB device 150 is performed (in the case of the data transfer in the IN direction.), the data transfer is not performed according to the device wire adapter protocol, and thus issuance of the Transfer Request and confirmation of the Transfer Result are not required.

Therefore, the DWA 110 according to the exemplary embodiment 1 can perform the data transfer without using the device wire adapter protocol, by performing the data transfer between the WUSB host 170 and the wired USB device 150 connected to the specific port SP, via a dedicated end point associated with the wired USB device 150. Thereby, since any unnecessary overhead does not occur when the data transfer is performed, communication efficiency can be improved.

Moreover, since the DWA 110 according to the exemplary embodiment 1 performs the data transfer between the WUSB host 170 and the wired USB device 160 connected to a port other than the specific port SP, according to the device wire adapter protocol, and performs the data transfer between the WUSB host 170 and the wired USB device 150 connected to the specific port SP, via the dedicated end point, the DWA 110 according to the exemplary embodiment 1 can operate as a composite device which also has a function as a WUSB Native device, in addition to a function as the device wire adapter.

### Exemplary Embodiment 2

Next, the DWA according to an exemplary embodiment 2 of the present invention will be described. Although the DWA 110 according to the above described Exemplary embodiment 1 has been described assuming that the wired USB device 150 connected to the specific port SP on the downstream side is not dynamically inserted and removed and is fixed, the DWA 110 according to the exemplary embodiment 2 will be described assuming that the wired USB device 150 is dynamically inserted and removed and is not fixed. As will be described later, the DWA 110 according to the exemplary embodiment 2 reads the descriptor information from the wired USB device 150 at a time point when the wired USB device 150 has been connected, and performs the process for changing the configuration information on the end point of the DWA 110 based on the read descriptor information, and thereby, can also deal with a case where the function of the wired USB device 150 is dynamically changed. It should be noted that, hereinafter, differences from Exemplary embodiment 1 are mainly described, and regarding the same configuration and process as Exemplary embodiment 1, descriptions thereof are omitted.

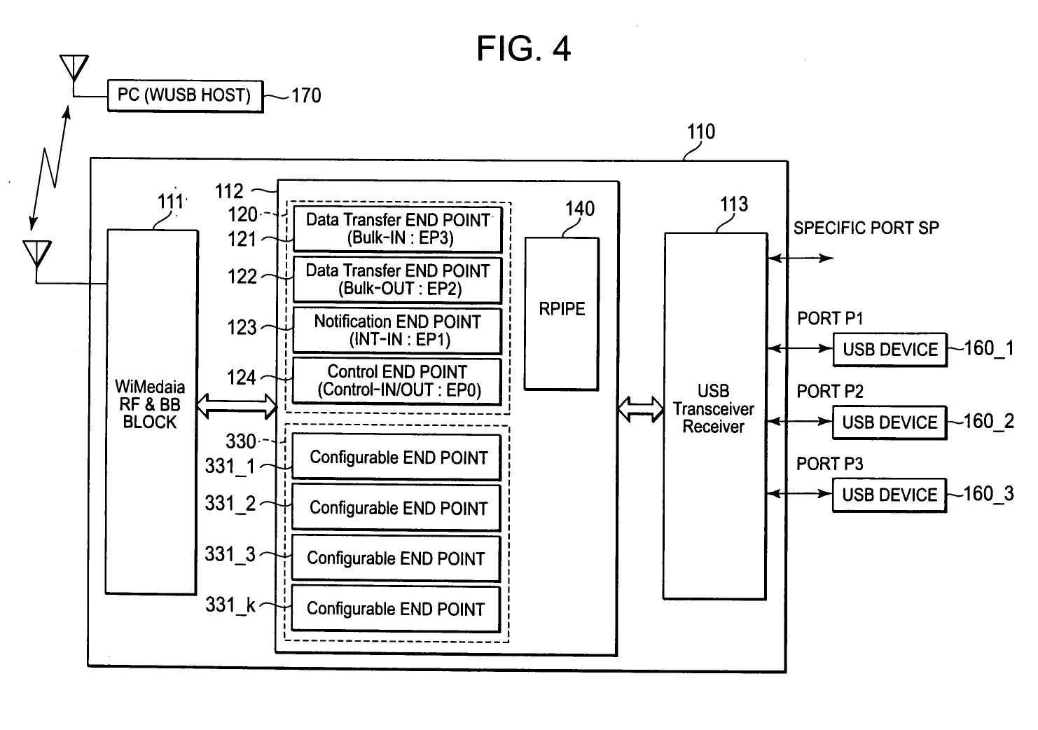

FIG. 4 is a block diagram showing the configuration of the DWA in the wireless USB communication system according to Exemplary embodiment 2 of the present invention. An example shown in FIG. 4 shows a state where the wired USB device has not been attached to the specific port SP in a case where the wired USB device is dynamically inserted into and removed from the specific port SP. Here, while the wired USB device has not been attached to the specific port SP, the wired USB devices 160_1 to 160_3 have already been attached to the port P1 to the port P3 on the downstream side of the DWA 110. It should be noted that since the WiMedia RF & BB block 111, the USB Transceiver Receiver 113, the RPIPE 140 and the WUSB end point 120 correspond to those of FIG. 1, respectively, descriptions thereof are omitted.

A WUSB end point 330 is used for the data transfer between the WUSB host 170 and the wired USB device 150 which is dynamically connected to the specific port SP. The WUSB end point 330 includes a Configurable end point 331_1 to a Configurable end point 331_{—}k (which may be hereinafter collectively referred to by reference numeral 331.) of which the configurations can be changed. Similar to the Configurable end point 231 shown in FIG. 1, the Configurable end point 331 is the end point on which the configuration information can be changed.

Here, a process for changing the configuration information on the Configurable end point 331 of the DWA 110 according to the exemplary embodiment 2 will be described. In the DWA 110 according to the exemplary embodiment 2, since the wired USB device 150 is dynamically inserted and removed, the configuration information changing process is executed at any of time points when the wired USB device 150 has been attached to the specific port SP, when the wired USB device 150 connected to the specific port SP has been removed, and when an instruction for disconnecting the wired USB device connected to the specific port SP has been received from the WUSB host 170. As will be described later, in such a configuration information changing process, the program of the DWA 110 (that is, the WUSB host controller 112) changes the configuration information on the end point.

Subsequently, the process until it becomes the state where the communication between the WUSB host 170 and the wired USB devices 150 and 160 can be started will be described. It should be noted that, hereinafter, a case where the process for changing the configuration information on the end point is performed by the DWA 110 at the time point when the wired USB device 150 has been attached to the specific port SP of the DWA 110 from the state shown in FIG. 4 will be described by way of example. Moreover, as will be described later, at the time point when the wired USB device 150 has been attached to the specific port SP, the DWA 110 performs communication control so that it can be recognized as another wireless USB device other than the DWA 110 by the WUSB host 170.

First, when the DWA 110 has been wirelessly connected to the WUSB host 170, the WUSB host 170 performs the enumeration with respect to the DWA 110. More specifically, the WUSB host 170 assigns the address which is unique in the system, to the DWA 110 (for example, the DWA 110 is assigned with Adr1.), and performs the configuration for the configuration of the end point of the DWA 110.

The WUSB host 170 which has recognized the configuration of the DWA 110 starts the operation for the communication with the DWA 110. Then, following the enumeration for the DWA 110, the WUSB host 170 performs the enumeration with respect to the wired USB device 160 connected to the DWA 110. The WUSB host 170 starts the operation for the communication with the wired USB device 160, from the time point when the configuration of the wired USB device 160 has been recognized.

The WUSB host 170, which has performed the enumeration process for the DWA 110 and the wired USB device 160, performs the communication with the wired USB devices 160_1 to 160_3 connected to the port P1 to the port P3, via the RPIPE 140.

Then, following the enumeration for the wired USB device 160, at the time point when the wired USB device 150 has been attached to the specific port SP of the DWA 110, the WUSB host 170 performs the enumeration with respect to the wired USB device 150 connected to the DWA 110. The WUSB host 170 starts the operation for the communication with the wired USB device 150, from the time point when the configuration of the wired USB device 150 has been recognized. It should be noted that details of the enumeration process with respect to the wired USB device 150 will be described later.

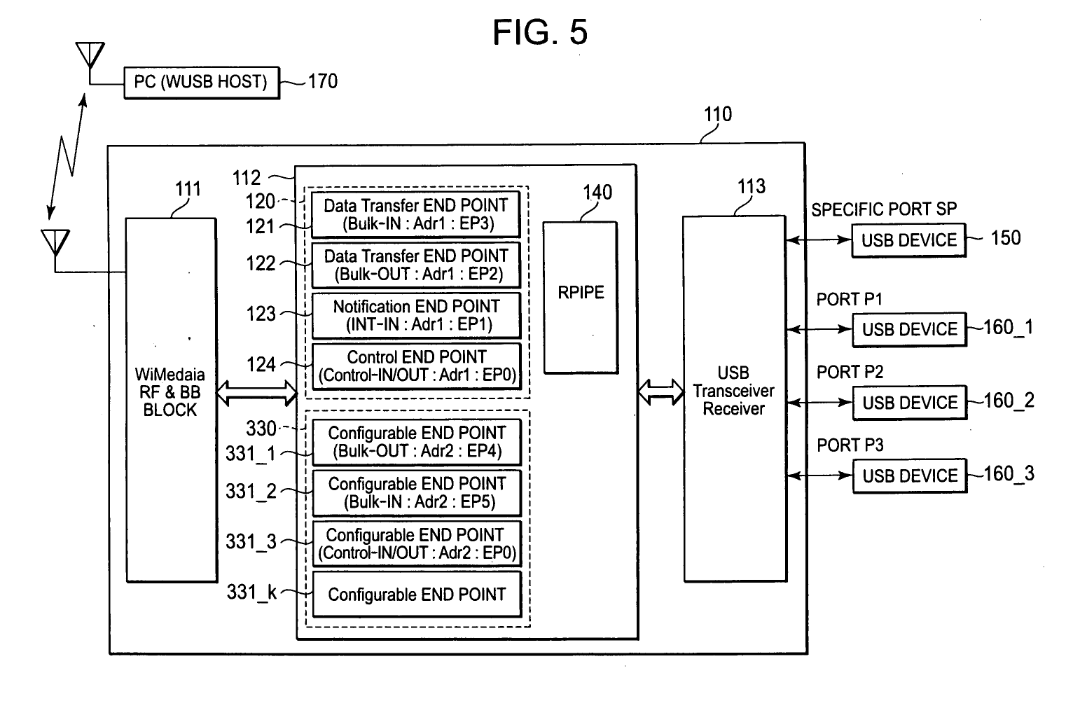

Hereinafter, the enumeration process with respect to the wired USB device 150 in a case where the wired USB device 150 has been attached to the DWA 110 shown in FIG. 4 will be specifically described by using FIG. 5.

First, if the wired USB device 150 has been attached, the DWA 110 detects the connection of the wired USB device 150, and reads the descriptor information from the wired USB device 150. Then, the DWA 110 changes the parameter of the Configurable end point 331 of the DWA 110 from the read descriptor information.

For example, FIG. 5 shows the configuration after the wired USB device 150 has been connected to the DWA 110 shown in FIG. 4 and the configuration information changing process has been performed. In an example shown in FIG. 5, the wired USB device 150 has the end point for the Bulk-IN transfer, the end point for the Bulk-OUT transfer, and the end point for the Control-IN/OUT transfer, and based on the descriptor information on the wired USB device 150 showing such a configuration, the configuration information on the Configurable end point 331_1 to the Configurable end point 331_3 is changed. Specifically, the parameters of the Configurable end point 331_1 to the Configurable end point 331_3 are changed depending on the configuration information on each end point of the wired USB device 150, and thereby, the configuration information is changed to the end point for the Bulk-OUT transfer (EP4), the end point for the Bulk-IN transfer (EP5), and the end point for the Control-IN/OUT transfer (EP0), respectively.

Then, the DWA 110 which has changed the configuration information on the end point performs a connection request to the WUSB host 170, as another WUSB device. If the connection has been permitted for the above described connection request, the DWA 110 transmits information on the change of the configuration information at the time of the enumeration process, to the WUSB host 170. In response to this, in addition to Add for causing the DWA 110 to operate as the DWA, the WUSB host 170 assigns Adr2 for causing the DWA 110 to operate as another WUSB device.

Thereby, the Configurable end point 331 on which the configuration information has been changed and the end point included in the wired USB device 150 are set to be one-to-one associated with each other, and a wireless communication operation with respect to the WUSB host 170 is started.

It should be noted that if the wired USB device 150 connected to the specific port SP has been removed from the DWA 110, if the instruction for disconnecting the wired USB device has been received from the WUSB host 170, or the like, the DWA 110 stops a function causing it to be recognized as another wireless USB device, and the wireless connection between the wired USB device 150 and the WUSB host 170 is disconnected. For example, if the wired USB device 150 has been removed from the DWA 110, the configuration information on the end point of the DWA 110 is initialized by transmitting a disconnect request from the DWA 110 to the WUSB host 170, and the wireless connection between the wired USB device 150 and the WUSB host 170 is disconnected. Here, the Configurable end point 331 set for the wired USB device 150 is released by the initialization of the configuration information, and the configuration of the DWA 110 returns to the configuration of the DWA 110 shown in FIG. 4.

It should be noted that a method of disconnecting the wireless connection between the wired USB device 150 and the WUSB host 170 is not limited thereto, and for example, the DWA 110 may stop a response to the Transfer Request from the WUSB host 170, and if the response has not occurred for a certain period of time, the connection related to the wired USB device 150 which does not respond may be disconnected by the WUSB host 170.

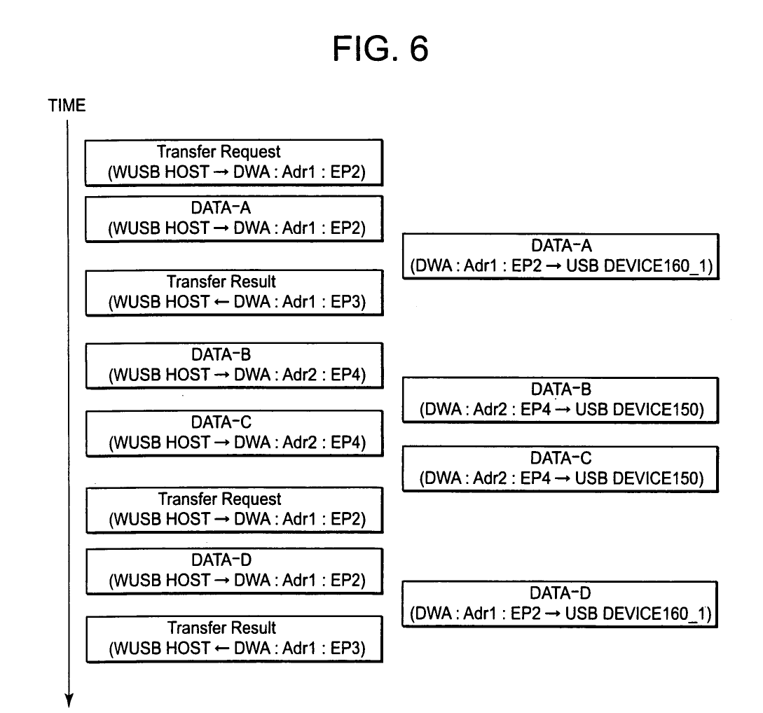

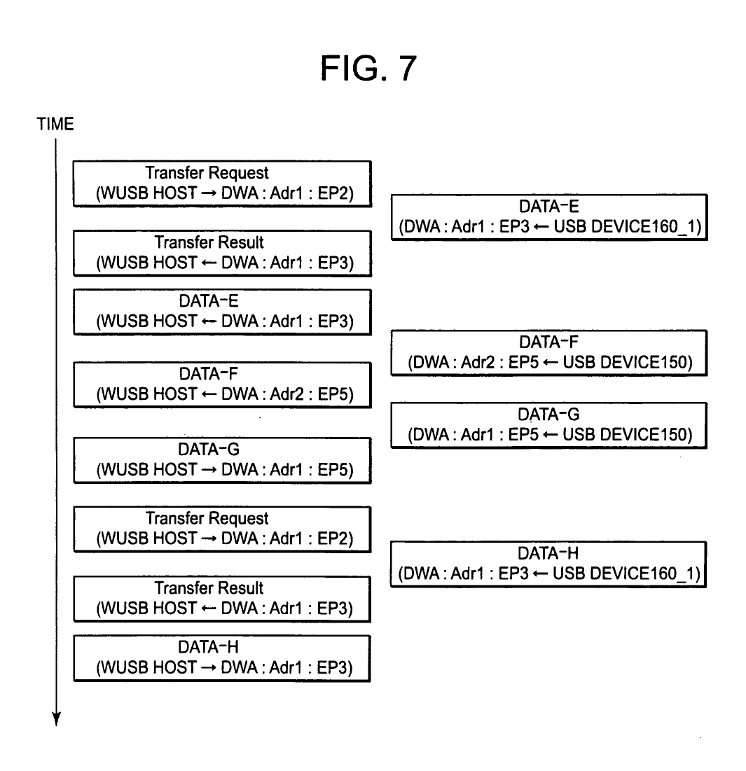

Hereinafter, with reference to FIGS. 6 and 7, the data transfer process performed via the DWA 110 according to the exemplary embodiment 2 will be described. In an example shown in FIG. 6, the data transfer process performed via the DWA 110 in the OUT direction will be described. In an example shown in FIG. 7, the data transfer process performed via the DWA 410 in the IN direction will be described.

It should be noted that the examples shown in FIGS. 6 and 7 will be described assuming that the wired USB devices 150 and 160 have the end point for the Bulk transfer, and the DWA 110 supports such wired USB devices 150 and 160. Consequently, the Bulk transfer will be described by way of example in the description of the data transfer process.

Moreover, in the examples shown in FIGS. 6 and 7, it is assumed that when the DWA 110 has been wirelessly connected to the WUSB host 170, Adr1 has already been assigned to the DWA 110 by the WUSB host 170, and the configuration for the configuration of the end point 120 of the DWA 110 has been performed. Furthermore, it is assumed that when the wired USB device 150 has been connected, Adr2 has been assigned to the DWA 110 by the WUSB host 170, and the configuration for the configuration information on the end point 330 of the DWA 110 has been performed depending on the configuration information on the end point of the wired USB device 150. Thereby, the WUSB host 170 performs the communication between the WUSB host 170 and the end point of the DWA 110 by designating the address and the end point number of the DWA 110, in the token packet to be transmitted.

First, the data transfer process to the wired USB device 160_1 in the OUT direction will be specifically described by using FIG. 6. Here, since the transfer of the DATA-A from the WUSB host 170 to the wired USB device 160_1 is the same as the case where the DATA-A is transferred from the WUSB host 430 to the wired USB device 420_2 in FIG. 9, the description thereof is omitted.

Next, the case where the DATA-B and the DATA-C are transferred to the wired USB device 150 will be specifically described by using FIG. 6. First, the DATA-B is transmitted from the WUSB host 170 to the DWA 110. The DWA 110 stores the received DATA-B in EP4 based on Adr2 and EP4 included in the token packet. Then, the DWA 110 transmits the DATA-B stored in EP4 to the end point for the Bulk transfer of the wired USB device 150. Subsequently, the DATA-C is transmitted similarly to the transmission of the DATA-B.

The data transfer process from the wired USB device 160_1 in the IN direction will be specifically described by using FIG. 7. Here, since the transfer of the DATA-E from the wired USB device 160_1 to the WUSB host 170 is the same as the case where the DATA-E is transferred from the wired USB device 420_2 to the WUSB host 430 in FIG. 10, the description thereof is omitted.

Next, the case where the DATA-F and the DATA-G are transferred from the wired USB device 150 to the WUSB host 170, that is, the case where the WUSB host 170 reads the data from the wired USB device 150, will be specifically described by using FIG. 7. First, an IN token is issued from the WUSB host 170 to EP5 of Adr2 of the DWA 110. The DWA 110 which has received the IN token further issues the IN token to the end point for the Control transfer of the wired USB device 150. The wired USB device 150 to which the IN token has been issued transmits the DATA-F from the end point for the Bulk transfer to the DWA 110. The DWA 110 which has received the DATA-F stores the received DATA-F in EP5 of Adr2. The DWA 110 performs the data transmission for the IN token from the WUSB host 170 by transmitting the stored DATA-F to the WUSB host 170. Subsequently, the DATA-G is transmitted similarly to the transmission of the DATA-F.

Therefore, also in the DWA 110 according to the exemplary embodiment 2, the data transfer is performed without using the device wire adapter protocol, by performing the data transfer between the WUSB host 170 and the wired USB device 150 connected to the specific port SP, via the dedicated end point associated with the wired USB device 150. Thereby, since any unnecessary overhead does not occur when the data transfer is performed, the communication efficiency can be improved.

Moreover, the DWA 110 according to the exemplary embodiment 2 can cause the WUSB host 170 to recognize the DWA 110 as being another different WUSB device, which, however, is physically a single device, by further assigning another address different from the address which has already been given, to the DWA 110. In other words, since the WUSB host 170 interprets the address of the WUSB device included in transmitted and received packet data, the WUSB host 170 recognizes the DWA 110 as if it were two different WUSB devices (the wireless USB device and the device wire adapter) when two different addresses are assigned to the DWA 110. Therefore, the DWA 110 can also be used as another WUSB Native device, in addition to the function as the device wire adapter.

### Exemplary Embodiment 3

Next, the DWA according to an exemplary embodiment 3 of the present invention will be described. The DWA 110 according to the exemplary embodiment 3 will be described assuming that the wired USB device 150 connected to the specific port SP on the downstream side is dynamically inserted and removed, and that the wired USB device 150 to be inserted and removed is a device of a USB Mass Storage Class. In other words, although the wired USB device 150 is dynamically inserted into and removed from the DWA 110, the function of the wired USB device 150 can be previously specified by limiting a device class of the wired USB device 150. Therefore, as will be described later, prior to the enumeration process performed by the DWA 110, based on the descriptor information on the device of the Mass Storage Class, the configuration information on the end point of the DWA 110 can be previously changed, and the control process in subsequent enumeration performed by the DWA 110 can be easier. It should be noted that, hereinafter, the differences from the exemplary embodiment 1 are mainly described, and regarding the same configuration and process as the exemplary embodiment 1, the descriptions thereof are omitted.

The configuration of the DWA according to the exemplary embodiment 3 is the same as the configuration of the DWA 110 shown in FIG. 1, and is different in that the wired USB device 150 connected to the specific port SP is the device of the Mass Storage Class. Here, the device of the Mass Storage Class is, for example, a medium such as a hard disk drive or a DVD drive.

Here, the process for changing the configuration information on the Configurable end point 231 of the DWA 110 according to the exemplary embodiment 3 will be described. In the DWA 110 according to the exemplary embodiment 3, the wired USB device 150 is the device of the Mass Storage Class. Consequently, for example, the manufacturing vendor previously changes the configuration information on the Configurable end point 231 by using the configuration information changing means, depending on the configuration information on the end point of the device of the Mass Storage Class.

It should be noted that since the process until it becomes the state where the WUSB host 170 can start the communication with the wired USB device 150 via the Configurable end point 231 on which the configuration information has been changed is the same as the process described in the above described the exemplary embodiment 1, the description thereof is omitted.

Subsequently, the data transfer process performed via the DWA 110 according to the exemplary embodiment 3 will be described. In the DWA 110 according to the exemplary embodiment 3, since the wired USB device 150 is the device of the Mass Storage Class, the data transfer between the WUSB host 170 and the wired USB device 150 is performed by a class driver of the Mass Storage Class. Consequently, the wired USB device 150 responds to a SCSI command issued by the class driver of the WUSB host 170, and thereby, media access from the WUSB host 170 is performed.

Hereinafter, the data transfer process between the WUSB host 170 and the wired USB device 150 will be specifically described. First, if the WUSB host 170 has recognized that the wired USB device 150 is the Mass Storage Class device, from the descriptor information on the wired USB device 150, the WUSB host 170 transmits the SCSI command via the DWA 110 to the wired USB device 150.

The DWA 110 which has received the SCSI command confirms whether or not the wired USB device 150 has been connected to the specific port SP, and returns response data in response to the SCSI command, depending on a connection state. If the wired USB device 150 has been connected, the DWA 110 returns it as the response data to the WUSB host 170. Moreover, the wired USB device 150 receives the SCSI command from the WUSB host 170 via EP4 or EP5 of the DWA 110. Then, the DWA 110 transmits the data read from the wired USB device 150, via EP4 or EP5 to the WUSB host 170.

If the wired USB device 150 has not been connected, the DWA 110 returns it as the response data to the WUSB host 170. If the WUSB host 170 has received the response data indicating that the wired USB device 150 has not been connected, the WUSB host 170 periodically transmits the SCSI command to the wired USB device 150 to confirm whether or not the connection of the wired USB device 150 exists. It should be noted that if the wired USB device 150 has been removed from the DWA 110, the DWA 110 returns it to the WUSB host 170.

In this way, the DWA 110 according to the exemplary embodiment 3 performs the communication control so that the WUSB host 170 has been caused to previously recognize the wired USB device 150 as a Removable device, and the WUSB host 170 is notified of a Removable state of the wired USB device 150 depending on the connection state of the wired USB device 150. Thereby, the dynamic insertion and removal of the wired USB device 150 are enabled.

Therefore, also in the DWA 110 according to the exemplary embodiment 3, the data transfer can be performed without using the device wire adapter protocol, by performing the data transfer between the WUSB host 170 and the wired USB device 150 connected to the specific port SP, via the dedicated end point associated with the wired USB device 150.

Moreover, since the data transfer between the WUSB host 170 and the wired USB device 150 connected to the specific port SP is performed via the dedicated end point, the DWA 110 according to the exemplary embodiment 3 can operate as the composite device which also has a function as the Mass Storage Class device that can be dynamically inserted and removed, in addition to the function as the device wire adapter.

Hereinbefore, as described in each of the above described exemplary embodiments, according to the DWA according to the present invention, the configuration information on the end point of the DWA is changed depending on the configuration information on the wired USB device connected to a specific down-port, the end point on which the configuration information has been changed is used for the communication with the WUSB host, and thereby, the communication between the wired USB device connected to the specific down-port and the WUSB host is performed via the dedicated end point. Thereby, the WUSB host can directly transmit the data to the end point of the wired USB device, not via the RPIPE, by directly designating the end point of the DWA which is associated with the end point of the wired USB device connected to the specific down-port. Therefore, when the data transfer between the WUSB host and the wired USB device connected to the specific down-port of the DWA is performed, occurrence of unnecessary commands can be suppressed, and the communication efficiency can be improved.

Moreover, as described in each of the above described exemplary embodiments, the DWA according to the present invention can operate as the composite device having a plurality of functions. In order to cause a conventional DWA to operate as the composite device, for the function of the WUSB device to be newly added, all hardware configurations required for realizing the above described function need to be mounted. In contrast to this, regarding the respective functions mounted in the DWA according to the present invention, the hardware configurations related to the WiMedia RF & BB block, the USB Transceiver Receiver and the like are used in common by the respective functions. In other words, in the DWA according to the present invention, the function of the WUSB device to be newly added can be realized without newly mounting portions related to the hardware configurations of the WiMedia RF & BB block and the like. Consequently, in the DWA according to the present invention, the composite device having the plurality of functions can be realized while an increase in the hardware related to wireless USB communication is suppressed.

It should be noted that the device connected to the specific down-port on the downstream side of the DWA is not limited to the wired USB device, and may be a USB hub. If the wired USB device has been connected to the downstream side of the USB hub, the DWA performs the data transfer between the WUSB host and the wired USB device connected via the USB hub.

It should be noted that if the wired USB device connected to the specific down-port on the downstream side of the DWA has an Isochronous end point, and the data transfer to/from the WUSB host is performed via the above described Isochronous end point, the configuration information on some end points in a plurality of end points of which the configurations can be changed may be changed, and Isochronous end points, of which the number corresponds to the number of the Isochronous end points included in the wired USB device, may be mounted in the DWA.

It should be noted that the present invention is not limited only to the above described exemplary embodiments, and of course, various changes can be made within the scope not deviating from the gist of the present invention.

Further, it is noted that Applicant's intent is to encompass equivalents of all claim elements, even if amended later during prosecution.

What is claimed is:

1. A device wire adapter which performs a data transfer between a host which has been wirelessly connected to an upstream side and a wired device which has been wired-connected to a downstream side, said device wire adapter comprising:
a control unit which controls the data transfer between said host and said wired device; and
a first end point on which a configuration information related to the data transfer can be changed,
wherein the data transfer between said host and said wired device is performed via said first end point on which said configuration information has been changed based on configuration information on an end point included in said wired device.

2. The device wire adapter according to claim 1, further comprising:
a first port to which said wired device is connected; and
a configuration information changing unit which changes the configuration information on said first end point based on the configuration information on the end point included in said wired device which is connected to said first port,
wherein said wired device is connected to said first port, and
wherein said control unit associates said first end point on which said configuration information has been changed by said configuration information changing unit, with the end point included in said wired device, so that said first end point on which said configuration information has been changed by said configuration information changing unit and the end point included in said wired device are one-to-one associated with each other, and performs the data transfer between said host and the end point included in said wired device via the associated end point.

3. The device wire adapter according to claim 1, further comprising:
a first port to which said wired device is connected, and
wherein if said wired device is connected to said first port, then said control unit changes the configuration information on said first end point based on the configuration information read from said wired device, associates said first end point on which said configuration information has been changed, with the end point included in said wired device, so that said first end point on which said configuration information has been changed and the end point included in said wired device are one-to-one associated with each other, and performs the data transfer between said host and the end point included in said wired device via the associated end point.

4. The device wire adapter according to claim 3, further comprising:
a second port to which said wired device is connected and which is different from said first port; and
a second end point on which said configuration information cannot be changed,
wherein if said wired device is connected to said second port, then said control unit performs the data transfer between said host and said wired device connected to said second port, based on a first address and identification information on said second end point, which are designated by said host, and
wherein if said wired device is connected to said first port, then said control unit performs the data transfer between said host and said wired device connected to said first port, based on a second address that is different from said first address, and identification information on said first end point, which are designated by said host.

5. The device wire adapter according to claim 1, further comprising:
a first port to which said wired device is connected; and
a configuration information changing unit which changes the configuration information on said first end point based on the configuration information on said wired device which is connected to said first port,
wherein the wired device which is connected to said first port comprises a wired device belonging to a predetermined device class, and
wherein if said wired device has been connected to said first port, then said control unit associates the first end point on which said configuration information has been changed by said configuration information changing unit, with the end point included in said wired device, so that the first end point on which said configuration information has been changed by said configuration information changing unit and the end point included in said wired device are one-to-one associated with each other, and performs the data transfer between said host and the end point included in said wired device via the associated end point.

6. The device wire adapter according to claim 5, wherein:
said predetermined device class comprises a USB Mass Storage Class; and
said control unit performs the data transfer between said host and the end point included in said wired device by returning response data depending on a connection state of said wired device via said associated end point to said host, in response to a command of said USB Mass Storage Class which is issued by said host.

7. The device wire adapter according to claim 1, wherein:
said configuration information includes various parameters related to the data transfer; and
said configuration information can be changed by changing at least one parameter among a transfer type and a transfer direction of the data transfer between said host and said wired device, an end point address of said first end point, as well as a maximum packet size and a maximum burst size of transmitted and received packets.

8. The device wire adapter according to claim 1, wherein the configuration information on said first end point is changed based on a descriptor information including the configuration information on the end point included in said wired device.

9. The device wire adapter according to claim 1, wherein said wired device comprises a wired USB (Universal Serial Bus) device.

10. The device wire adapter according to claim 1, wherein said host performs a data communication between said host and said device wire adapter according to a wireless USB standard.

11. The device wire adapter according to claim 2, wherein said wired device which is connected to said first port comprises a USB hub in which a wired USB device is connected to a downstream side of the wired device.

12. A communication control method for a device wire adapter which performs a data transfer between a host which has been wirelessly connected to an upstream side and a wired device which has been wired-connected to a downstream side, said communication control method comprising:
performing the data transfer between said host and said wired device via a first end point on which configuration information has been changed based on configuration information, which is related to the data transfer, on an end point included in said wired device.

13. The communication control method according to claim 12, further comprising:
changing a configuration information so that said wired device is connected to a first port, and the configuration information on said first end point is changed based on the configuration information on the end point of said wired device connected to said first port,
wherein said performing the data transfer comprises:
associating said first end point on which said configuration information has been changed in said changing the configuration information, with the end point included in said wired device, so that said first end point on which said configuration information has been changed in said configuration information changing and the end point included in said wired device are one-to-one associated with each other; and
performing the data transfer between said host and the end point included in said wired device via the end point associated in said associating the end point.

14. The communication control method according to claim 12, wherein said performing the data transfer comprises:
if said wired device has been connected to a first port, then changing the configuration information on said first end point based on the configuration information read from said wired device;
associating said first end point on which said configuration information has been changed in said changing the configuration information, with the end point included in said wired device, so that said first end point on which said configuration information has been changed in said changing the configuration information and the end point included in said wired device are one-to-one associated with each other; and
performing the data transfer between said host and the end point included in said wired device via the end point associated in said associating the end point.

15. The communication control method according to claim 14, further including, in the device wire adapter, a second end point on which said configuration information, and
wherein said performing the data transfer includes:
if said wired device has been connected to a second port which is different from said first port, then performing the data transfer between said host and said wired device connected to said second port, based on a first address and identification information on said second end point, which are designated by said host; and
if said wired device has been connected to said first port, then performing the data transfer between said host and said wired device connected to said first port, based on a second address that is different from said first address, and identification information on said first end point, which are designated by said host.

16. The communication control method according to claim 12, wherein:
the wired device which is connected to a first port comprises a wired device belonging to a predetermined device class;
said communication control method further comprises changing a configuration information on said first end point based on configuration information on said predetermined device class; and
said performing the data transfer includes:
if said wired device has been connected to said first port, then associating the first end point on which said configuration information has been changed in said changing the configuration information, with the end point included in said wired device, so that the first end point on which said configuration information has been changed in said changing the configuration information and the end point included in said wired device are one-to-one associated with each other, and performing the data transfer between said host and the end point included in said wired device via the associated end point.

17. The communication control method according to claim 16, wherein:
said predetermined device class comprises a USB Mass Storage Class; and
said changing the data transfer includes:
performing the data transfer between said host and the end point included in said wired device by returning response data depending on a connection state of said wired device via said associated end point to said host, in response to a command of said USB Mass Storage Class which is issued by said host.

18. The communication control method according to claim 12, wherein:
said configuration information includes various parameters related to the data transfer; and
said configuration information can be changed by changing at least one parameter among a transfer type and a transfer direction of the data transfer between said host and said wired device, an end point address of said first end point, as well as a maximum packet size and a maximum burst size of transmitted and received packets.

19. The communication control method according to claim 12, wherein the configuration information on said first end point is changed based on descriptor information including the configuration information on the end point included in said wired device.

20. The communication control method according to claim 12, wherein said wired device comprises a wired USB (Universal Serial Bus) device.

21. The communication control method according to claim 12, wherein said host performs data communication between said host and said device wire adapter according to a wireless USB standard.

22. The communication control method according to claim 13, wherein said wired device which is connected to said first port comprises a USB hub in which a wired USB device is connected to a downstream side of the wired device.

23. A method of performing a data transfer, comprising:
performing a first data transfer between a wireless universal serial bus (USB) host and a first USB device by using a data transfer end point and a remote pipe; and
performing a second data transfer between the wireless USB host and a second USB device by using a configurable end point without using the remote pipe.
